(19) United States
(12) Patent Application Publication
(10) Pub. No.: US 2011/0035281 A1
(43) Pub. Date: Feb. 10, 2011

(54) Filter for displaying advertisements over a network

(76) Inventors: Ari Bernstein, New York, NY (US); Tami Cohen, New York, NY (US); Teddy Jawde, Brooklyn, NY (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/462,806

(22) Filed: Aug. 10, 2009

(51) Int. Cl. G06Q 30/00

(52) U.S. Cl. 705/14.54; 705/14.71

(57) ABSTRACT

Systems and methods are provided for selling one or more advertisements and displaying the one or more advertisements on a web page within a website based on contextual relevance and further based on a matching of at least one keyword with text located on the web page or on the website. In some embodiments the matching results in the advertisement being displayed while in others the matching results in preventing the advertisement from being displayed.

### FIELD OF THE INVENTION

The invention relates generally to systems and methods for displaying advertisements over a network and, more particularly, to systems and methods for selecting keyword(s) and using one or more of the keywords to determine if a relevant advertisement should be allowed to be displayed on a web page.

### BACKGROUND OF THE INVENTION

Advertisements are often displayed in a web page in response to a user (i) typing the Universal Resource Locator (“URL”) for that web page into a web browser or (ii) selecting a link for the web page from a list of search results. Typically, each advertisement is associated with a single advertiser and may include text and/or graphics and/or audio. Upon selection of an advertisement (e.g., left click with a mouse or rolling over the area with a pointer), the web browser can be redirected to a web page associated with the advertisement from which the user can, for example, receive additional information, place online orders, or complete other transactions. Advertisements are typically sold based on a set fee, a cost-per-click (CPC), or a cost-per-thousand (CPM) viewers.

Advertisements can be displayed in a web page in a variety of ways. An advertiser can elect a specific web page in which to place the advertisement(s). Alternatively, advertisements can be selected for display within a web page substantially in real time, based on demographical information of a particular user who is accessing the web page. Advertisements may also be displayed in substantially real time on a particular web page or in a particular location on a web page based on subject matter displayed on that page.

With all of the above forms of substantially real time advertisement placement systems it is possible for an advertiser to have an advertisement placed on a web page that may be relevant but is undesirable to that advertiser.

It would be advantageous to provide an improved system and method for selling and displaying advertisements over the internet. It would be further advantageous to provide a system for placing advertisements in substantially real time based on one or more of the conventional methods with an additional filtering step to ensure that the advertisement is placed according to the advertiser's requirements.

### SUMMARY OF THE INVENTION

Embodiments of the invention provide systems and methods for selling and placing advertisements (“ads”) over a communications network. While preferable that these are the same entity, it is conceivable that the seller and placement services are separate entities. The advertisements can be displayed in substantially real time based on demographic information of a user and/or contextual relevance of the advertisement to the web page and further based on a filter that matches one or more key words to the content of the web page.

Aspects of the invention provide systems for the sale and display of ads over a network. The system may include a database configured to store at least one advertisement from an advertiser and an advertisement selection application. The advertisement selection application receives a request for advertising from a user computer that is attempting to access a website. The request may include one or more advertisement selection criteria which may be employed by the ad selection application to select an advertisement. In response to the request, the selection application determines if any advertisements match the criteria provided with the request. If such an advertisement is located a filter is employed which compares at least one keyword associated with the advertiser with a set of words associated with a web page from the website. If the comparison results in a match the selected advertisement is displayed.

Aspects of the invention provide systems for the sale and display of ads over a network. The system may include a database configured to store at least one advertisement from an advertiser and an advertisement selection application. The advertisement selection application receives a request for advertising from a user computer that is attempting to access a website. The request may include one or more advertisement selection criteria which may be employed by the ad selection application to select an advertisement. In response to the request, the selection application determines if any advertisements match the criteria provided with the request. If such an advertisement is located a filter is employed which compares at least one keyword associated with the advertiser with a set of word(s) associated with a web page from the website. If the comparison results in a match the selected advertisement is not displayed.

Embodiments of the invention include methods for selecting and displaying advertisements within a website. The website includes at least one web page. The method includes storing advertisements from an advertiser and receiving a request for a stored advertisement. In response to the request, the method includes determining that at least one of the stored advertisements qualifies to be displayed on the website. Subsequent to the qualification determination, comparing at least one keyword associated with the advertisement's advertiser with at least a portion of the content from the web page and if a match exists selecting the advertisement for display.

Embodiments of the invention include methods for selecting and displaying advertisements within a website. The website includes at least one web page. The method includes storing advertisements from an advertiser and receiving a request for a stored advertisement. In response to the request, the method includes determining that at least one of the stored advertisements qualifies to be displayed on the website. Subsequent to the qualification determination, comparing at least one keyword associated with the advertisement's advertiser with at least a portion of the content from the web page and if a match exists rejecting the advertisement.

### BRIEF DESCRIPTION OF THE DRAWINGS

For a better understanding of the invention, reference is made to the following description, taken in conjunction with the accompanying drawings, in which like reference characters refer to like parts throughout, and in which:

FIG. 1 is a block diagram of a system for displaying advertisements over a network (e.g., Internet) in accordance with embodiments of the invention;

FIGS. 2-4 are flowcharts of illustrative stages involved in the display of advertisements within pages (e.g., web pages) over a network in accordance with embodiments of the invention; and,

FIG. 5 illustrates two pages of an exemplary website showing a possible location for an advertisement and illustrating potential text for comparison with keyword(s).

### DETAILED DESCRIPTION OF THE INVENTION

Embodiments of the invention relate to systems and methods for selling and displaying advertisements on a network. While this invention is applicable to many types of networks, an example of a suitable network is the Internet. For ease of explanation, the remainder of the description shall be limited to the Internet. However, those skilled in the art will recognize that the description could be applied to other types of networks as well.

Advertisements may include text, graphics, sound, video, or any combination thereof. For ease of explanation, the following description shall be limited to text and graphics and combinations thereof. However, those skilled in the art will recognize that the same or a similar description can be applied to the other advertisement formats, and thus the specific description selection is not intended to be limiting in this regard.

Conventional advertisement placement systems provide advertisers with the ability to bid on topics, which may be applied to search engine results, content on a web page or content of a website. Typically, a vector value is determined for the advertisement and that vector value is compare to vector values for a web page, web pages, a website or a URL. This same convention may be employed with the invention. However, to further refine the placement of an advertisement, or to ensure that an advertisement is not placed in an undesirable location, a further filter is employed. Subsequent to making an initial determination that a particular advertisement qualifies to be served with a web page or website, a secondary determination is made. While not preferred, it is also considered within the scope of the invention that the secondary determination is made simultaneously with the initial determination. A keyword or keywords is/are compared to words on the webpage and/or words on the website and/or words in the search results. The words that are used for the comparison can be limited to a few select words, such as the title of the page, the title of the website, the first x lines of text on the page, the last x lines on the page, the words proximal to the placement location, etc. Those skilled in the art will recognize that the selection of words to use for the comparison is a design choice and should not be taken as a limiting factor of the invention. There may be as few as one word employed for the comparison and as many as every word associated with the website.

When the filter result is positive, in other words, a match is found, exact or a predetermined percentage or words is found to match the text of the web page, that information is used to determine whether or not to serve the advertisement for display. For example, if the word pornography is located and the advertiser does not want to advertise on any web page or website that employs that word, the system would be configured to reject the advertisement as a result of a positive match. Thus the advertiser would select the word pornography as a keyword and if that word was found by the filter the advertiser's advertisement would not be placed, even though the website or the web page qualified based on the topic search (or any other conventional criteria search). Alternatively, if an advertiser wants an advertisement placed only on web pages or websites that discuss, for example, Tiger Woods, the advertiser could select the keywords Tiger and Woods and only when the filter found the two words would the advertiser's advertisement be served for display. Optionally, and preferably, the advertiser is provided the ability to select a search that only resulted in a positive if the words are found within a selected number of words of each other or an exact match is found. Those skilled in the art will recognize that these are conventional Boolean search capabilities and thus need not be further discussed herein.

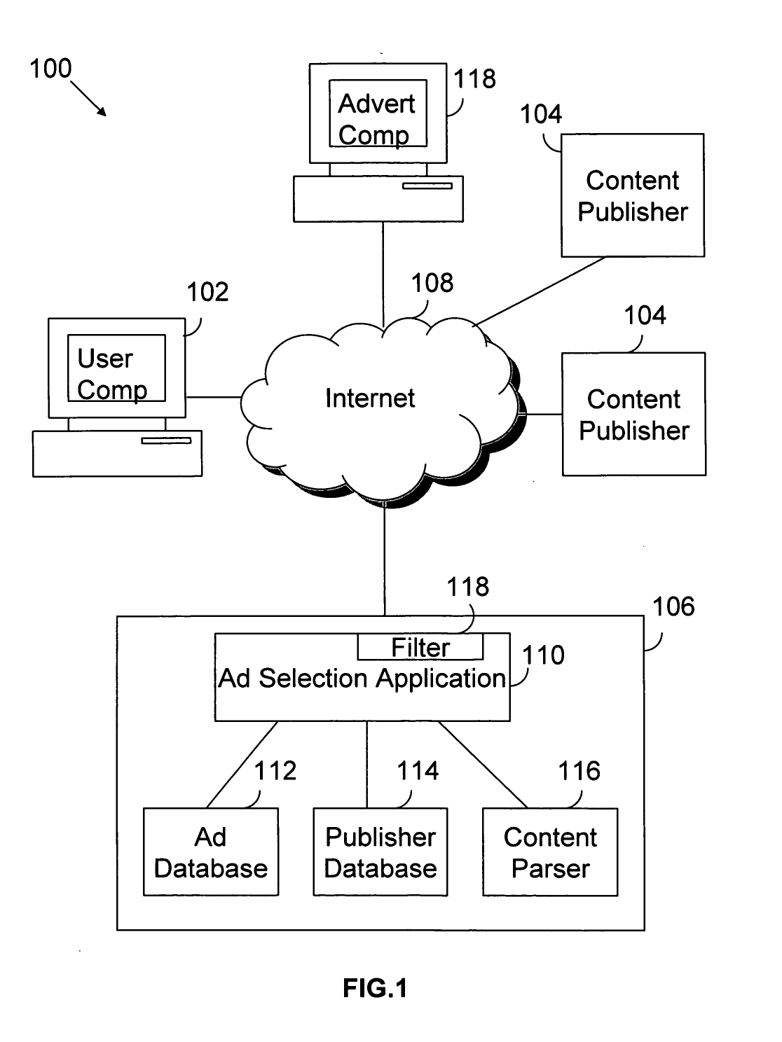

FIG. 1 is a block diagram of a system 100 for selling advertisements for display over a network (e.g., the Internet) in accordance with embodiments of the invention. System 100 includes user computer(s) 102, content publishers 104, advertisement (“ad”) system 106 and advertiser computer 118 that communicate with one another over network 108. While advertiser computer 118 has been illustrated as a separate device for ease of explanation, it will be apparent that an advertiser may simply employ a user computer 102 to access the system. Each of user computer(s) 102, advertiser computer 118, content publishers 104, and ad system 106 may be in electrical communication with internet 108 via a suitable communications capability such as a cable or satellite connection, a local area network (“LAN”), or any other suitable wired, wireless, or optical connection, or a combination thereof.

User computer 102 and advertiser computer 118 may be any suitable computing equipment for accessing content (e.g., web pages) over Internet 108 and displaying advertisements to end user(s). For example, as shown in FIG. 1, computers 102 and 118 may be desktop computers. In other examples, computers 102 and 118 may be laptop computers, telephones (e.g., mobile phones), personal digital assistants (“PDA”) such as BlackBerry™ or Trio™ devices, or any other suitable computing devices. Computers 102 and 118 may have a web browser (e.g., Internet Explorer™, Netscape Navigator™, Mozilla Firefox™, etc.) operating thereon for facilitating communications over internet 108. The web browser may access and read marked-up documents (e.g., HTML documents) from content publishers 104 and then translate and render those documents into web pages that can be viewed by end users at computers 102 and 118. Typically, system 100 will include multiple user computers 102 and advertiser computers 118 although only one user computer 102 and advertiser computer 118 are shown in FIG. 1 to avoid overcomplicating the drawing.

A content publisher 104 may be any publisher of web page(s) over internet 108. For example, a content publisher 104 may be the computing system responsible for publishing the web pages viewable at nydailynews.com. Another content publisher may be the computing system responsible for publishing the web pages viewable at nypost.com. Each content publisher 104 may include one or more web servers for receiving and responding to requests from user computers 102 for access to the web page(s) provided by the content publisher. A person employing user computer 102 may request access to a given web page by entering a Universal Resource Locator (“URL”) for that web page into an address region of a web browser display or by selecting a link for the web page from a list of search results (e.g., Google search results) or a link of a web page.

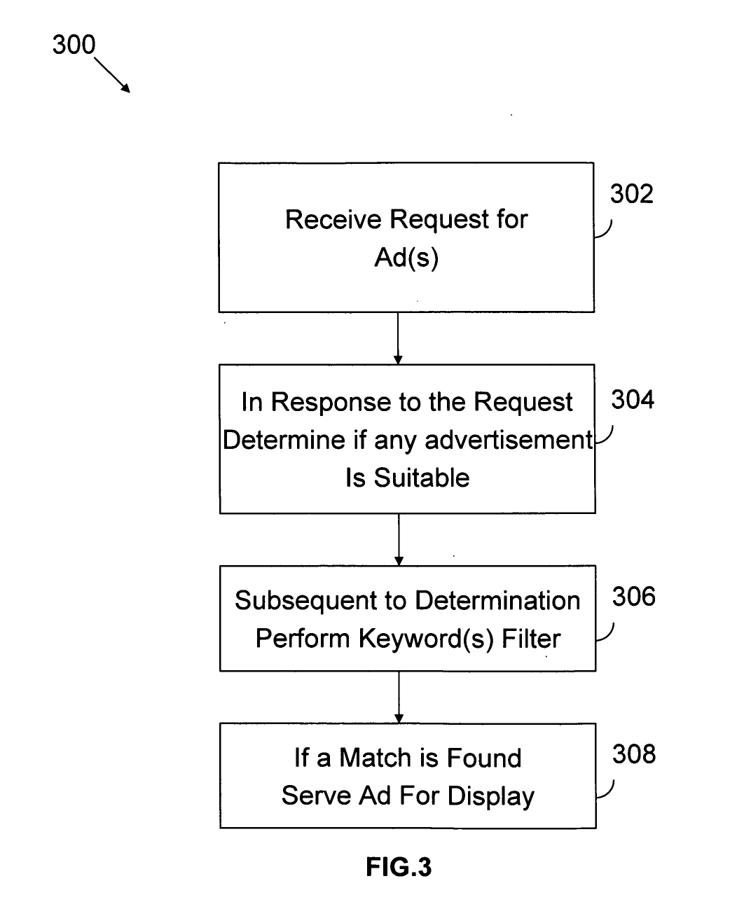

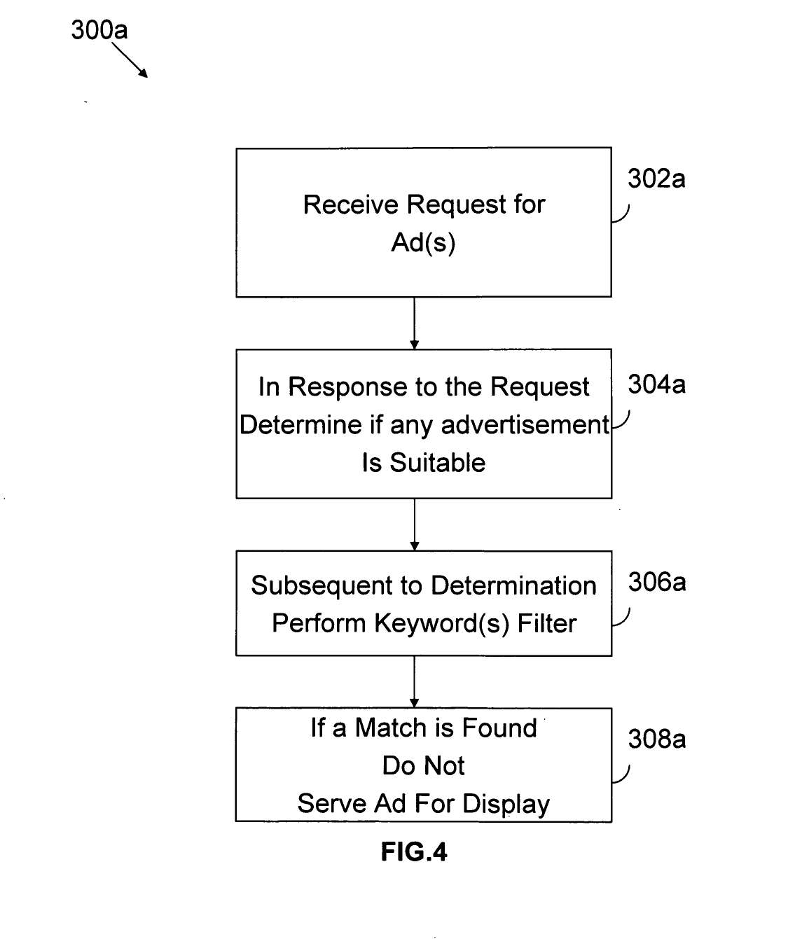

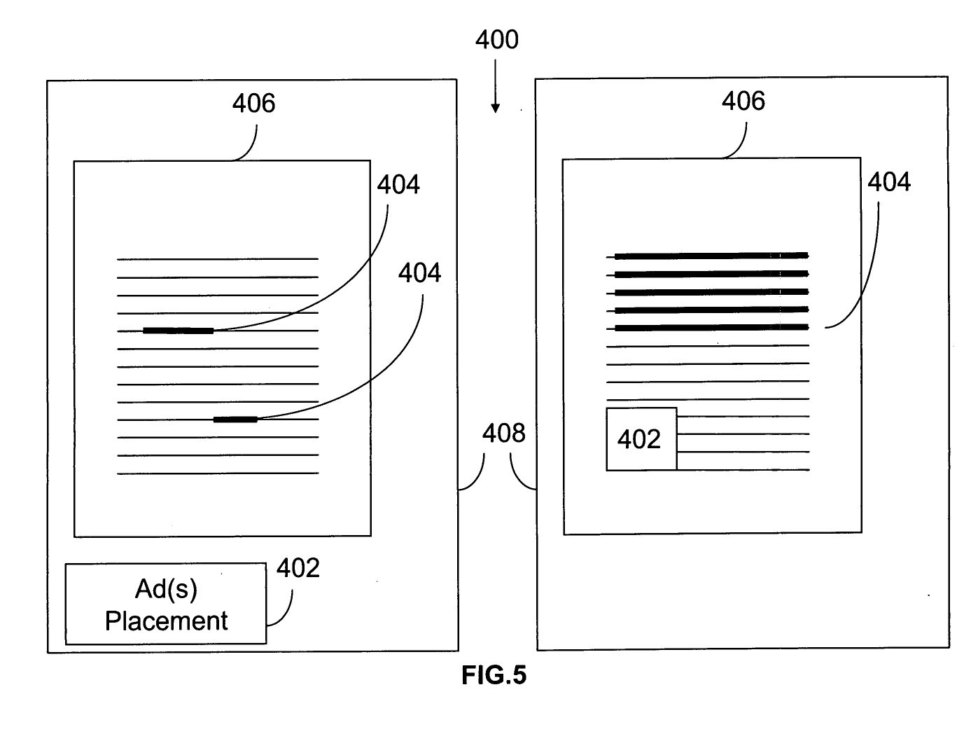

Ad system 106 may include ad selection application 110, ad database 112, publisher database 114, and content parser 116. While the description employs the term database, those skilled in the art will recognize that any sufficient form of organized storage could be employed and still fall within the scope of the invention. Ad selection application 110 may include any suitable hardware, software, or combination thereof for receiving and responding to requests for advertisements received by ad system 106 via Internet 108. For example, ad selection application 110 may include one or more web server(s). Responsive to the requests, ad selection application 110 may select and transmit one or more advertisements 402 (FIG. 5) for display within web pages provided by a content publisher 104. Ad selection application 110 initially determines that an advertisement 402 may be suitable for display within the web pages based at least in part on the relevance of the ad to the content of the web pages and/or past performance of the ad (or similar ads) upon placement within web pages by ad system 106, a combination thereof or any other conventional method of determining when to serve advertisements with a web page. Subsequent to making the initial determination, but prior to serving an advertisement 402, ad selection application 110 employing filter 118 performs a comparison of one or more keywords associated with the advertiser to one or more words associated with the website 400 or web page(s) 408 (FIG. 5). If the comparison results in a match, depending on the system configuration, ad selection application 110 serves (FIG. 3) or refuses to serve (FIG. 4) advertisement 402 for display within the web pages 408. Those skilled in the art will recognize that while filter 118 has been described as part of ad selection application 110, it is conceivable that the comparison is performed by a separate module without departing from the scope of the invention.

Ad database 112 may store advertisement(s) for display within web pages 408 provided by content publishers 104 and accessed by user computers 102. Ads stored in database 112 may be downloaded from advertiser(s) over Internet 108 or received by ad selection system 106 according to any other suitable approach (e.g., uploaded from portable storage media provided by the advertisers). Alternatively or additionally, ad database 112 may store information associated with the advertisements including, for example, keyword(s), topics/themes (e.g., for determining relevance of the ads to given web pages), associated text and/or graphic(s) (e.g., for simultaneous or separate display), information regarding past performance of the advertisement (e.g., number of click-throughs), associated advertiser identifiers (e.g., for linking to billing information for the advertisers and for linking to other advertisements for the same advertiser), bid and/or purchase amounts by the advertisers, and/or other criteria regarding the display of the ads within web pages provided by content publishers 104 (e.g., an identification of one or more web pages in which a given ad is eligible for display). As used herein, a theme or topic refers to the contextual gist of content (e.g., advertisement or web page). Illustrative, non-exclusive, examples of themes/topics are “San Francisco 49ers”, “Airplane Accident”, and “Bahamas Travel”.

Publisher database 114 may store information regarding content publishers 104 within system 100 such as information identifying the web pages provided by content publishers 104 (e.g., a list of their respective URLs), information regarding the content (e.g., topics/themes) of those web pages, information regarding advertisements displayed previously on those web pages, the revenue generated therefrom and/or a portion or all of the text 404 from the web page(s). Alternatively or additionally, publisher database 114 may store information regarding preferences of content publishers 104 such as information regarding the types of advertisements eligible for display on the web pages provided by content publishers 104 and/or information regarding the placement of those advertisements within the web pages (e.g., location, format, and size). In the embodiment illustrated in FIG. 1, ad database 112 and publisher database 114 are separate. However, the same database could be employed for both purposes without departing from the scope of the invention.

Content parser 116 may include any suitable hardware, software, or combination thereof for parsing web pages provided by content publishers 104 and identifying topic(s)/theme(s) or other indicia associated therewith. Content parser 116 may read publisher's content and relate it through semantic vectors to one or more topic(s)/theme(s) with an associated relevancy score. For example, a page of content provided by Publisher A may be determined to be about “Travel” with a relevancy of 1.0 (100%), “Vacations” with a relevancy of 0.86 (86%), “Cruises” with a relevancy of 0.72 (72%), and “Live Entertainment” with a relevancy of 0.51 (51%). The topics/themes and associated relevancy outputs of content parser 116 may provide specific ad placement opportunities for ads associated with the fixed placement advertisement 402. The parsed information may be used by ad application 110 to select ad(s) that are most or very relevant to the identified topic(s)/theme(s) for placement within the web pages.

Content parser 116 may be configured to return a maximum number (e.g., 10) of themes/topics associated with each page. It may also be configured to return a specific amount of text from the web page. Alternatively, there may be a different number or no limit to the number of themes/topics that can be identified by content parser 116. Content parser 116 may return a ranked list of themes/topics that identifies the themes/topics in order of greatest to least relevant to the contents of the web page (e.g., such that ads associated with the most relevant theme/topic are more likely to be displayed earlier in a sequence of ads selected by system 106 for display). Those skilled in the art will recognize that other orders are equally useful and may be employed. In embodiments of the invention, content parser 116 may operate substantially in real-time, whereby web pages are parsed at substantially the same time they are accessed by user computers 102. In embodiments of the invention, content parser 116 may parse the web pages periodically, continuously, or according to any other suitable approach (e.g., automatically upon receipt of an electronic notification from a content publisher 104 that the content of the web page(s) has changed or under the control of an operator associated with ad system 106). In various embodiments, content parser 116 may be activated selectively by ad system 106, based on a determination of the best yield between “hard match” (i.e., selecting ads specifically intended for placement within given web pages or sections thereof) and/or semantic matching facilitated by content parser 116. In some embodiments, when ad system 106 determines suitable ad(s) to display on a given page provided by a content publisher 106, system 106 may take into account relevancy, effective bid (e.g., the actual price paid for a click given market dynamics), max bid price (willingness to pay), past performance, other criteria, or combinations thereof as they relate to that specific page. Subsequent to these determinations, ad system 106 further determines suitability of an advertisement based on a comparison of keyword(s) associated with an advertiser and text from the web page, website, etc.

Ad system 106 may establish relationships with one or more content publishers 104 in order to allow system 106 to place ads within the web pages provided by the publishers upon access of the pages by user computers 102. In some embodiments, video ad system 106 may limit the content publishers 104 that are permitted to associate with system 106 to “premium” publishers such as, for example, providers of web pages that typically receive a minimum number of visits per period (e.g., day, portion of day, month, year). One or more threshold criteria may be established that govern whether a given content publisher is permitted to be associated with ad system 106. This may increase the willingness of advertisers to place their ads through ad system 106 and increase the revenue that can be derived per ad placement and/or subsequent action (e.g., click-through) by an end user of user computer 102.

Establishing a relationship with a content publisher 104 may include negotiating a revenue-sharing arrangement between the ad system 106 and content publisher 104 for revenue generated as a result of displaying ads within the web pages and/or subsequent actions of end-users of user computers 102. Alternatively or additionally, establishing a relationship with a content publisher 104 may include managing interoperability between system 106 and the content publisher to, for example, minimize the latency perceived by end-users of user computers 102. Managing system interoperability may include establishing a protocol for communications upon access of the web pages by end users of user computers 102 (e.g., communications between content publisher 104/user computer 102, user computer 102/ad system 106, and/or content publisher 104/ad system 106).

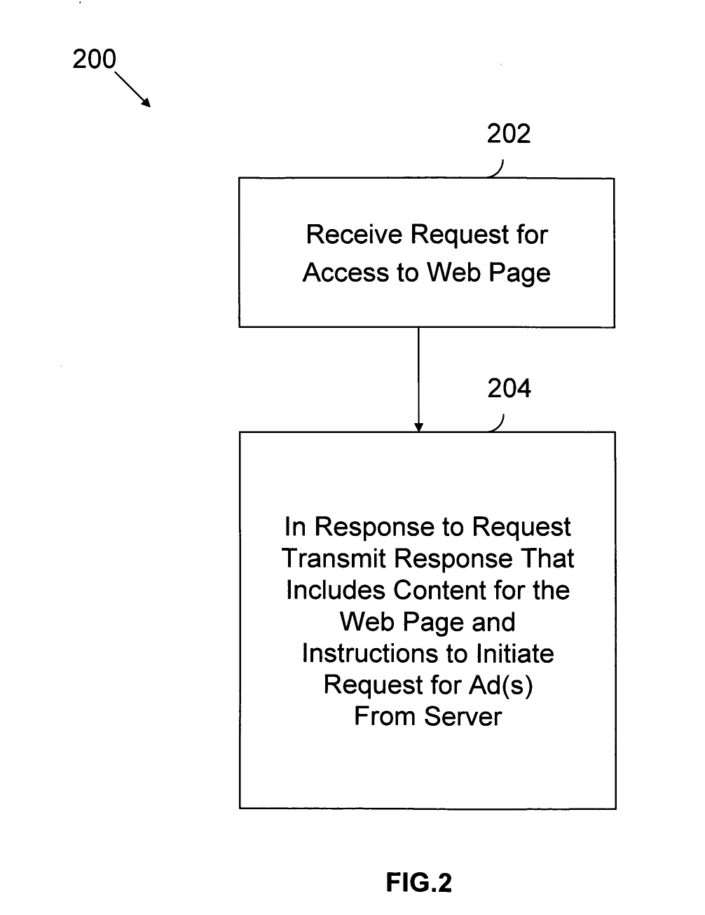

FIGS. 2-4 are flowcharts illustrating stages involved in selection and display of ads within web pages in accordance with various embodiments of the invention. FIGS. 2 and 3 show embodiments of a communications protocol between a user computer 102 and content provider 104 (FIG. 2), and subsequently between user computer 102 and ad system 106 (FIGS. 3-4), that may be employed upon a request by user computer 102 for access to a web page provided by content publisher 104. Referring to FIG. 2, at stage 202 a request for access to a web page may be received. For example, a web server associated with content publisher 104 may receive an HTTP (Hypertext Transfer Protocol) request for access to a web page provided by the publisher from a web browser operating on user computer 102. At stage 204, content publisher 104 may transmit a response (e.g., HTTP response) to the requesting user computer 102, where the response includes both content (could be text and/or topics) for the requested web page as well as instructions to initiate a request for ad(s) from ad system 106. The content and/or instructions may be received by user computer 102 in the form of markup code, which may be translated and processed by the web browser operating on user computer 102. Preferably, the markup code is structured such that user computer 102 sends the request for ads to system 106 at substantially the same time as or even before user computer 102 translates the markup code necessary for rendering the web page display. If the web page is at least partially displayed before the ad(s) are received from ad system 106 (e.g., when ads database 112 does not include any advertisements suitable for display within the web page), the markup code may provide a message or other content (e.g., advertisement) for display within the region of the web page otherwise reserved for the ad. A request for an advertisement may be initiated by a user computer 102 or from content publisher 104 to ad system 106.

Referring to FIGS. 3 and 4, at stage 302/302a a request for ad(s) may be received, wherein the request may include one or more ad selection criteria (e.g., location, size, and/or format of the ad within a web page). For example, ad system 106 may receive a request for ad(s) from user computer 102, which request is formatted in accordance with the instructions received by user computer 102 from content publisher 104 at stage 204 (FIG. 2). Other examples of ad selection criteria that may be included in the request received by ad system 106 at stage 302/302a may be the identity of the content publisher, specific web page accessed (e.g., identified by URL), and/or end-user demographic data and/or preferences (e.g., provided by content provider 104 in the instructions sent to user computer 102 through the use of cookies by content provider 104, or maintained locally by user computer 102). At stage 304/304a, an ad, or a set of ads, may be selected in accordance with the ad selection criteria and/or one or more additional criteria such as relevance, past performance, association with the same advertiser, or a combination thereof. Once it is determined at stage 304 or 304a that an ad is suitable for display with the web page, a further filtering step is performed at stage 306 or 306a. In this step one or more keywords associated with the advertisement's advertiser is/are compared with text from the web page(s). If a match is found or if a sufficient number of words match then in embodiments depicted by FIG. 3 at step 308, the selected ad(s) may be transmitted for display within a web page. The ads displayed within the web page may be at least partly interactive. For example, in response to an end user selecting an ad the web browser operating on user computer 102 may be redirected to a website of the advertiser. If a match is found or if a sufficient number of words match then in embodiments depicted by FIG. 4 at step 308a, it may be determined that the selected ad(s) should not be transmitted for display.

A sample operation of various embodiments of the invention will now be described in relation to FIGS. 1-5. An advertiser operating from advertiser computer 118 accesses ad system 116 either directly via the Internet 108 or via a content publisher 104. Alternatively, the advertiser contacts an entity that controls ad system 106 or some third party and that entity performs the actions on behalf of the advertiser. Subsequent to or simultaneous with accessing ad system 106 the advertiser is provided the option to purchase one or more keywords. The advertiser may be provided with the option to select one set of keyword(s) that will enable his/her advertisement(s) to be displayed and another set of keyword(s) that will prevent his/her advertisement(s) from being displayed. Those skilled in the art will recognize that the advertiser may only be provided with one of the two options and still fall within the scope of the invention. Although not required, the advertiser could be provided with the option to associate the keywords with one advertisement, a group of advertisements or all advertisements for that advertiser. Once the advertiser selects the keyword(s) the system will filter selections of the advertiser's advertisements based at least in part on a comparison of these keywords to a set of text associated with a web page, web site or search listing results. If the comparison results in a match or a partial match (depending on the particular configuration of the system) the advertisement will either be selected for display or prevented from being displayed (depending on the particular configuration of the system and/or the election of the advertiser).

Thus it is seen that systems and methods are provided for selling, selecting and displaying advertisements over the Internet. Although particular embodiments have been disclosed herein in detail, this has been done for purposes of illustration only, and is not intended to be limiting with respect to the scope of the claims, which follow. In particular, it is contemplated by the inventors that various substitutions, alterations, and modifications may be made without departing from the spirit and scope of the invention as defined by the claims. A non-exhaustive list of such modifications includes filtering based on location, format and or size of the proposed advertisement. For example, an advertiser could be provided the opportunity to reject or only accept advertisements that are smaller than a particular size or larger than a particular size, or a particular shape or format. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implemented, at least in part, using a computer system, it will be appreciated that a computer program for implementing at least part of the described methods and/or the described systems is envisaged as an aspect of the invention. The computer system may be any suitable apparatus, system or device, electronic, optical, or a combination thereof. For example, the computer system may be a programmable data processing apparatus, a general purpose computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

What is claimed is:

1. A system for selecting and displaying advertisements over a network, the system comprising:
a database configured to store at least one advertisement from an advertiser and at least one keyword associated with the advertiser; and
an advertisement selection application configured to:
receive a request for advertising from a user computer, wherein the request is generated by the user computer in accordance with instructions provided to the user computer by a content publisher upon the user computer accessing a website of the content publisher, wherein the website includes at least one web page and said at least one web page includes text; and,
in response to the request, determine that at least one advertisement of an advertiser from the database is suitable for display within a web page of the website; and
comparing said at least one keyword to at least a subset of said text.

2. The system according to claim 1, wherein said advertisement selection application is configured to compare said at least one keyword to said at least a subset of said text subsequent to making said determination.

3. The system according to claim 2, wherein said at least one keyword and said at least a subset of said text relate to a location of said advertisement on said web page.

4. The system according to claim 2, wherein said at least one keyword and said at least a subset of said text relate to a format of said advertisement on said web page.

5. The system according to claim 2, wherein said at least one keyword and said at least a subset of said text relate to a size of said advertisement on said web page.

6. The system according to claim 1, wherein said comparing results in at least a partial match, said advertisement selection application being further configured to select said advertisement for display within said web page.

7. The system according to claim 1, wherein said comparing results in at least a partial match, said advertisement selection application being further configured to ensure that said advertisement is not selected for display within said web page.

8. A method for selecting and displaying advertisements within a website, wherein the website includes at least one web page and the at least one web page includes text, the method comprising:
storing a plurality of advertisements from an advertiser and at least one keyword;
receiving a request for at least one of said plurality of advertisements of said advertiser; and
in response to the request, determining that at least one advertisement of the advertiser from the database is suitable for display within a web page of the website; and,
comparing said at least one keyword to at least a subset of said text.

9. The system according to claim 8, wherein said comparing is performed subsequent to making said determination.

10. The method according to claim 8, wherein said comparing results in at least a partial match, further comprising selecting said advertisement for display within said web page.

11. The method according to claim 8, wherein said comparing results in at least a partial match, further comprising ensuring that said advertisement is not selected for display within said web page.

12. A system for selecting and displaying advertisements over a communications network, the system comprising:
a database configured to store a plurality of an advertiser's advertisements and at least one keyword associated with the advertiser, the advertisements designed to be displayed on a content provider's website, the website comprising at least a web page, the web page including at least a set of text; and,
advertisement selection means for receiving a request for advertising from a user computer, determining that at least one advertiser's advertisement from the database is suitable for display within a web page of the website and comparing said at least one keyword to at least a subset of the text.

13. The system according to claim 12, wherein said advertisement selection mean is configured to compare said at least one keyword to said at least a subset of said text subsequent to making said determination.

14. The system according to claim 12, wherein said advertising selection means is also for selecting said advertisement for display within said web page when said comparing results in at least a partial match.

15. The system according to claim 12, wherein said advertising selection means is also for ensuring that said advertisement is not selected for display within said web page when said comparing results in at least a partial match.

16. A method of selling advertising for a website of a content provider over network comprising:
providing an advertiser with an option of bidding on at least one topic for placement of an advertisement on a contextually relevant web page; and,
providing said advertiser with an additional option of associating one or more keywords with said advertisement to ensure that said advertisement will only be displayed with a web page that displays at least one of said one or more keywords.

17. A method of selling advertising for a website of a content provider over network comprising:
providing an advertiser with an option of bidding on at least one topic for placement of an advertisement on a contextually relevant web page; and,
providing said advertiser with an additional option of associating one or more keywords with said advertisement to ensure that said advertisement will not be displayed with a web page that displays at least one of said one or more keywords.
